(19) United States
(12) Patent Application Publication
(10) Pub. No.: US 2022/0111402 A1
(43) Pub. Date: Apr. 14, 2022

(54) METHOD FOR OPERATING A CENTRIFUGE DEVICE

(71) Applicant: Ferrum Process Systems AG, Schafisheim (CH)

(72) Inventor: Marcel MÜHLEBACH, Rupperswil (CH)

(21) Appl. No.: 17/276,330

(22) PCT Filed: Nov. 6, 2018
(86) PCT No.: PCT/EP2018/080338

§ 371 Date: Mar. 15, 2021

(51) Int. Cl. B04B 13/00; B04B 15/06; B04B 3/00; B04B 11/04; B04B 11/02; G01F 23/292

(52) U.S. Cl. CPC B04B 13/00; B04B 15/06; B04B 3/00; G01N 2021/8411; B04B 11/02; G01F 23/292; B04B 2013/006; B04B 11/043

(57) ABSTRACT

A method for operating a centrifuge device, the centrifuge device including a centrifuge having a light detector and the light source arranged such that detection of a filling material parameter is carried out in an interior of a centrifuge drum, and a software module for a plausibility check of the filling material parameter. The software module is connected to the light detector. The method for operating the centrifuge device includes illuminating a part of a surface of the filling material with the light source, receiving a light reflected from the filling material by the light detector and generating a corresponding detection signal, a plausibility check of the detection signal of the light detector by the software module, processing a plausible detection signal by the software module, and generating an output signal from the plausible detection signal by the software module.

### CROSS-REFERENCE TO RELATED APPLICATIONS

This application is a U.S. National Stage application of International Application No. PCT/EP2018/080338, filed Nov. 6, 2018, the contents of which are hereby incorporated herein by reference.

### BACKGROUND

### Field of the Invention

The invention relates to a method for operating a centrifuge device, to a centrifuge device and to an integrable device for use in a method.

### Background Information

Conventional centrifuges can be used both for drying moist substances or moist substance mixtures and for general solid/liquid separation (i.e. the product is the liquid). Thus as can be understood, centrifuges are widely spread in a variety of designs and are used in a variety of fields. For example, discontinuously operating centrifuges, such as scraper centrifuges, are preferred for drying highly pure pharmaceutical products, while, in particular when large amounts of a solid-liquid mixture are to be continuously separated, continuously operating pusher centrifuges are used advantageously. Depending on the requirement, single-stage or multi-stage pusher centrifuges as well as so-called double pusher centrifuges are used.

In the various types of the latter mentioned class of pusher centrifuges, a solid-liquid mixture, for example a suspension or a moist salt or salt mixture, is supplied through an inlet pipe via a mixture distributor to a fast-rotating screen drum, which comprises a filter screen, so that the liquid phase is separated by the filter screen due to the centrifugal forces acting, while a solid cake is separated on the inside of the drum wall. In the rotating drum, an essentially disk-shaped, synchronously co-rotating pusher plate device is arranged, which oscillates in the axial direction with a certain amplitude in the screen drum, so that part of the dried solid cake is pushed out at one end of the screen drum. With the opposite movement of the pusher plate device, an area of the drum adjacent to the pusher plate device is released, which can then be fed again with a new mixture.

Most scraper centrifuges are equipped with so-called filling level measuring devices in order to monitor the amount of the supplied mixture.

### SUMMARY

In the state of the art, different methods and devices for monitoring the filling level and the interior of the centrifuge are known. Such a method and such a device are known from DE 37 26 227 C2. There, a sensor arm projects into the interior of the centrifuge drum and slides with its tip on the surface of the mixture present in the centrifuge drum. The sensor arm is arranged laterally out of the centrifuge drum via an axis and connected to a rotation angle encoder. The degree of filling of the mixture in the centrifuge drum can thus be determined by detecting the angle of rotation. In addition, the temperature of the surface to be sensed can be determined by a thermo sensor provided at the sensor tip.

It has been determined that this method and device has the disadvantage that sensor elements must project into the process chamber of the centrifuge. Furthermore, when feeling a liquid surface, no statement can be made about the amount of solid matter below the liquid. The method known from this is only applicable for filter centrifuges and some designs of discontinuous sedimentation centrifuges. A similar method and a similar device are also known from the reference “Der Thermofüllkontrollregler”, in: Chemie.-Ing.-Technik 62 (1990), page 304 to 306.

Furthermore, filling control regulators are known which are used in discontinuously operating filter centrifuges and consist of a runner, which swings into the drum. The movement of the runner into the drum is stopped by the rotating liquid ring by contact with the liquid rotating at the drum rotational speed, and a statement about the filling level in the centrifuge can be made by arranging suitable sensors on the moving part of the runner bearing or runner drive.

A filling level measuring device can also be equipped with a kind of paddle, which swivels into the centrifuge at a fixed angle. As soon as said paddle comes into contact with the cake or the liquid supernatant, a back swing mechanism is triggered and the paddle swivels back again to its resting position. Disadvantages of such mechanical filling level measurements are wear, deposits on the paddle, splashes due to contact of the paddle with the cake/the suspension and often, for example air currents on the cake surfaces cause the paddle to trigger too early.

Methods and devices for radiometric filling level monitoring of centrifuges are also known. Here, the adsorption of radioactive radiation is measured. The adsorption of radioactive radiation depends on the mass in the radiation field, so that the densities of the media can be used to calculate back to a filling level. Since the proportion of solids to liquids changes constantly during the filtration process, no absolute statement can be made about the ratio of the two media to each other or about the total filling level of mixtures of phases of different density in the centrifuge.

Although devices for radiometric filling level monitoring can be arranged outside the process chamber of the centrifuge, the expenditure of using radiometric devices is very high due to safety regulations.

Devices for ultrasonic filling level measurement are also known, whereby an ultrasonic sensor arranged inside the centrifuge directs a measuring beam onto the surface of the mixture and measures the distance to it, from which the filling level can be determined.

The disadvantage here is that the ultrasonic sensor must also be arranged inside the centrifuge drum and is exposed to corrosion, where it requires extensive maintenance. In the case of an explosion-proof design of such an ultrasonic sensor, its large installation volume is also disadvantageous. In addition, the measuring beam of the ultrasonic sensor, which is dependent on a limited energy density and therefore operates in a low frequency range, can be deflected at high relative speed between the measuring head and the medium to be measured, thus reducing operational safety.

Ultrasonic sensors can also be arranged outside the centrifuge, wherein the sound beam is deflected into the centrifuge by deflection. However, the measurement accuracy of ultrasonic sensors is strongly dependent on the density and temperature of the product and they have a relatively large beam angle.

Another possibility of measuring the filling level of a centrifuge is to couple the centrifuge to a load cell or a measuring box. This allows a statement to be made about how much product is inside the centrifuge drum. The advantage of this is that the load cell is located outside the process chamber. However, such a filling level measurement is basically problematic because the ratio between the maximum filling weight of the centrifuge and the dead weight of the centrifuge is about 1:50 to 1:100. In addition, it is not possible to distinguish between a solid and a liquid filling in this way, so that it is not possible to determine whether the measured filling weight is attributable to the filter cake or to the medium to be filtered. Another disadvantage is that in the event of uneven loading of the centrifuge and the associated unbalanced run, the weight detection via a load cell is essentially complicated by the unbalance-related vibration superimposition.

From DE 40 41 923 A1, a method is known for detecting the differential torque between drum and screw in a decanter. In this method, the degree of filling in the discharge area of the decanter is detected by measuring the torque. However, no statement can be made about the solids content within the sedimentation section of the decanter. The method can also only be used to regulate decanters in the upper limit range, i.e. with almost 100% filling of the discharge area of the screw with product, as is usual, for example, in sewage sludge separation. This method cannot be used to control or regulate decanters, which operate far below the upper limit range.

In continuously operating centrifuges (e.g. decanter centrifuges) it is important to know exactly the proportion of the solids inside the centrifuge in order to achieve an optimum performance and an optimum degree of separation. For this purpose, it is necessary to know the filling level of the solids in the discharge area and the ratio of solids to liquids in the entire centrifuge.

In discontinuously operating centrifuges, the steps of filling with the solid-liquid mixture, washing (displacement of unwanted primary liquid) and dry spinning of the filter cake take place one after the other. In order to allow the separation process to run optimally under different filling conditions, both the filling level of solids and the filling level of liquids must be detected. It is also important to detect the time of penetration of the suspension liquid into the filter cake. Depending on the filling levels and the liquid immersion point, the step sequence and the duration of the steps can be adapted to the respective requirements of the product to be filtered. The aim is not to discharge the separated solids from the centrifuge until the required product quality (residual moisture) has been achieved. On the other hand, however, the time at which this product quality is achieved should not be exceeded, as valuable production time and thus production capacity is lost as a result. In particular, a liquid supernatant in the centrifuge can lead to wave formation, which can lead to unbalance and consequently to damages.

Furthermore, a method is known from EP 0 724 912 A1 in which vibration frequencies and intensities of the centrifuge are detected as electrical signals by at least one vibration pick-up on the centrifuge, that the signals are subjected to a frequency spectrum analysis, that individual harmonic vibrations are isolated from the detected frequency spectrum and that subsequently the intensities (amplitudes) inherent in a respective harmonic vibration are determined for a time interval. Using this method, measured variables for a large number of operating parameters can already be detected with a single vibration pick-up, which can be arranged on the centrifuge outside the process chamber. On the basis of these measured variables, statements can be made, for example, about the filling level, about the ratio of liquid to solid. However, since no parameter of the surface of the solid cake in the centrifuge is detected, no statement can be made about the purity of the product.

WO 2017/054934 comprises a device for analyzing and monitoring the contents of a centrifuge. Here, at least a part of the interior of the centrifuge is illuminated by a broadband light source and a spectral analysis of the light reflected by the filling material is carried out by an optical band pass filter and a light detector. Signals are generated by the light detectors, which are then processed. In response to the processed signals from the light detector arrangement, a control signal is output to control the centrifugal force and thereby to control the separation of solid and liquid phases.

However, such optical sensors, in particular in the visible light range, have the enormous disadvantage that, inter alia, signal loss and false signals can occur. Due to such signal interference of the sensors, the centrifuge can be overridden and understeered. Thus, no regular operation and no analogous control of the centrifuge are possible. Such signal interference can occur, inter alia, due to uneven distribution of the cake surface, soiling, splashes, particles in the atmosphere, foam and many other factors.

It is therefore the object of the invention to provide an improved method for operating a centrifuge device with which the problems from the state of the art described above can be significantly reduced or more or less completely avoided.

The subjects of the invention meeting these objects are characterized by the features described herein.

Embodiments of the invention relate to a methods for operating a centrifuge device. In one embodiment, the centrifuge device comprises, inter glia, a centrifuge in which a centrifuge drum is rotatably arranged about an axis of rotation. Furthermore, the centrifuge device comprises a light detector and a light source. The light detector and the light source are arranged on the centrifuge device in such a way that a detection of a filling material parameter can be carried out in an interior of the centrifuge drum. In addition, the centrifuge device comprises a software module for plausibility check of the filling material parameter detected by the light detector, wherein the software module is connected/can be connected to the light detector by an inlet for receiving a detection signal. The method according to one embodiment of the invention for operating the centrifuge device by detecting the filling material parameter of the filling material inside the centrifuge drum comprises the following steps. Illuminating at least a part of a surface of the filling material in the centrifuge drum with the light source. Receiving a light reflected from the filling material by the light detector and generating a corresponding detection signal. The detection signal of the light detector is checked for plausibility by the software module. The detection signal checked for plausibility is processed by the software module and at least one output signal is generated from the plausible (checked for plausibility) detection signal by the software module. The steps described above can be carried out in parallel and/or one after the other in the operating state of the centrifuge.

In addition to the steps mentioned above, various calibration steps can also be carried out (depending on which filling material parameters are detected).

The method according to one embodiment of the invention is carried out with the centrifuge device in particular by a program, especially by a computer program, wherein the program is preferably carried out by a suitable electronic device. Specifically, the plausibility check can be carried out via a kind of black box device.

In principle, the centrifuge device according to one embodiment of the invention can be checked via the software module depending on the detection signals. Within the framework of embodiments of the present invention, checking a centrifuge device can be understood as monitoring, manipulating and controlling/regulating a centrifuge device. In particular, the centrifuge device is monitored by the light detector and manipulated, controlled and/or regulated by the software module. Thus, the method according to one embodiment of the invention can in particular be a method for monitoring and checking the separation of a solid and a liquid phase and/or a filling level and/or a drying state of the filling material and/or a degree of purity of a product located in the centrifuge drum and/or a liquid supernatant (e.g. predictions of a possible start of flooding) and/or the turbidity of the filtrate (in the case of thrust, this is an indication that screens are worn out and should be replaced).

Within the framework of embodiments of the invention, the output signal is to be understood in particular as an interpretation of the detection signal from the software module and thus of the filling material parameter, wherein this interpretation can be used to decide on the change or retention of the operating parameters.

Within the framework of embodiments of the invention, the light detector is to be understood as a detector that can detect electromagnetic waves. Electromagnetic waves (also electromagnetic radiation) are to be understood, inter alia, as gamma radiation, X-rays, UV radiation, infrared radiation, microwave radiation and, in particular, visible light. Thus, the light detector can detect, inter alia, radiation in the wavelength range of 400-700 nm, less than 5 pm, 10-380 nm (in particular 380-315 nm, 315-280 nm, 280-200 nm, 200-100 nm, 121-10 nm), 1 mm and 780 nm (in particular 0.78-1.4 μm, 1.4-3.0 μm, 3-50 μm, 50-1000 μm) and 300-1 mm.

The light source is thus to be understood as a source; which emits electromagnetic waves, preferably in one of the wavelength ranges mentioned above, wherein the electromagnetic waves emitted by the light source interact with the filling material in such a way that the radiation reflected by the filling material can be detected by the light detector.

The light source can comprise a broadband light source or a monochromatic light source. Here, a laser, for example, can be understood as a monochromatic light source.

In addition, the light detector can be designed as a light detector arrangement with a plurality of light detectors. By using a broadband light source and by arranging an optical bandpass filter in front of each of the numerous light detectors, a spectral analysis of the light reflected by the filling material can be carried out. When using a light detector arrangement with a plurality of light detectors, different light detectors can detect different wavelengths. Thus, in particular, each light detector can be adapted to measure a predetermined wavelength or a predetermined wavelength range within the wavelength range of the broadband light source/or a plurality of different light sources. In an embodiment of the invention, the sensitivity of the light detectors can be adapted by arranging a light filter in front of the light detector. Light filters are, inter alia, optical bandpass filters, prismatic filters and optical gratings. In this way, the light detectors with a corresponding light filter, even the light detectors that are basically designed for the same wavelength range, can only detect a predetermined wavelength or a predetermined wavelength range of the entire possible wavelength range of the light detector, since all other wavelengths are filtered out by the light filter.

In particular, light sources can also be radiation sources. A halogen lamp (20-80 Watt, preferably 50 Watt), a xenon flash lamp and/or a light emitting diode (LED) can be used, inter alia, as radiation sources for broadband light in the wavelength range of 400-700 nm. Helium neon lasers (632.8 nm), carbon dioxide lasers (10.6 μm), excimer lasers, Nd-YAG lasers, laser diodes, titanium sapphire lasers, color center lasers and free-electron lasers (for directed radiation in the microwave range up to the X-ray range) can be used, inter alia, as monochromatic light sources. Transit time tubes such as klystrons, travelling wave tubes, magnetrons, gun diodes for fixed frequencies and backward-wave oscillators can be used, inter alia, as radiation sources for microwaves. Mercury vapor lamps, quartz lamps, black light lamps, ultraviolet lasers (excimer), UV light-emitting diodes and UV cold cathode tubes can be used as radiation sources for UV radiation. Thermal radiators such as incandescent bulbs, radiant heaters, halogen radiators, quartz radiators and infrared lamps can be used as radiation sources for infrared radiation. X-ray tubes can be used as radiation sources for X-rays. ⁶⁰Co, ⁷⁵Se, ¹⁶⁹Yb, ⁹⁹Tc, ¹²³I, ¹³¹I, ¹³³Xe, ¹¹¹In and ¹⁹²Ir can be used, inter alia, as radiation sources for gamma radiation.

The light detector and the light source can be positioned either inside or outside the centrifuge drum. Preferably, the light detector and the light source are arranged on a flange of the centrifuge device, in particular on a sight glass for observation of the interior of the centrifuge. In principle, the centrifuge device can comprise any type of centrifuge, including a batch centrifuge and a continuous centrifuge.

According to an embodiment of the invention, the light detector and the light source can be arranged separately or side by side. In principle, the light source can also be integrated into the light detector. It should only be ensured that the light reflected by the filling material could be at least partially detected by the light detector.

A camera (e.g. CantyVision process camera) can be used, inter alia, as a light detector for visible light. For the detection of UV radiation, X-rays, microwaves and infrared radiation, corresponding UV, X-rays, microwave and infrared cameras are of course suitable as light detectors. These cameras are based on image conversion of the corresponding radiation into visible light. Here, the converted signal of the visible light can be used as a detection signal for plausibility check. The term camera is to be interpreted correspondingly broadly according to the previous description. According to one object of the present application, a camera is in principle a light detector, which can convert electromagnetic radiation of any wavelength or wavelength range into an image. Also other common detectors known in the state of the art could of course be used as light detectors.

In an embodiment of the invention, the light detector with the light source can also be a radar device. Here, the light detector is a radar detector such as circulators, directional couplers and nullodes with semiconductors and the light source is a radar transmitter (such as PAT (power amplifier transmitter; klystron, cross field amplifier, semiconductor, . . . ) or POT (power oscillator transmitter; magnetron, diode, . . . ). Preferably, an 80 GHz radar (such as Vegapuls) can be used, using a highly focused beam. The method according to one embodiment of the invention, can be carried out independently of foam/density, temperature, conductivity, moisture and dust generation and also other disturbing factors with an appropriate radar device. In particular, reflective surfaces are detected by tile radar device, wherein the method can be carried out depending on the dielectric constant of the product. Distance, direction, surface, course and speed, in particular the filling level, can be measured, inter alia, with the radar device. The direct signals visualized by a PPI visual display unit can be used as a detection signal. When using the radar device, the reflection at the filling material surface is preferably measured over the signal propagation time.

The radar sensor can operate with high-frequency radar pulses emitted by an antenna and reflected from the surface of the filling medium due to the change in the Dk value (relative dielectric constant). The transit time of the reflected radar pulse is usually directly proportional to the distance travelled.

Whether and how single or multiple (different) light sources and single or multiple (different) light detectors are used depends on the application. To generate detection signals, the light sources can be used e.g. as spotlights with predeterminable clocking, with several wavelengths or wavelength ranges. There is therefore a wide range of possibilities for generating and checking for plausibility of a large number of detection signals. In particular, a first detection signal (a plurality of first detection signals) of a first wavelength (of a first wavelength range) can be compared and selected with a second detection signal (a plurality of second detection signals) of a second wavelength (of a second wavelength range) for plausibility check. It is also possible that a large number of detection signals are recorded in one measuring period and these detection signals are checked for plausibility by a cross-comparison with each other.

Within the framework of embodiments of the invention, the cross-comparison is a juxtaposition of two or more detection signals in order to check the plausibility of the detection signals with regard to a certain criterion (such as mean value, difference, temporal course, etc.) and thus to select them into plausible and non-plausible detection signals.

The software module of the centrifuge device can comprise in particular a centrifuge control unit and a processing unit. The centrifuge control unit can be designed to control/to regulate and also to check the centrifuge operating parameters in order to react to the output signals checked for plausibility by the processing unit. The processing unit can be designed to process and to check the plausibility of the detection signals by the light detector. Here, the processing unit can be in particular a CPU. If a camera is used as a light detector, the image signal of the camera is processed and checked for plausibility by the software module. In particular, the intensity and color of the filling material surface and its changes can be used in a predeterminable image area.

In an embodiment of the invention, the output signal described above can also be a control signal. Here, the control signal can be designed to change and/or to maintain the operating parameters of the centrifuge device. Thus, depending on the measured parameters, it is determined whether a change of the operating parameters of the centrifuge device is necessary. The operating parameters can then be adapted (controlled/regulated) by a control signal/output signal.

In an embodiment of the invention, a selection of the detection signal/detection signals can be made during the plausibility check of the detection signal or a plurality of detection signals, and a division of the detection signal/detection signals into plausible and non-plausible detection signals can be made during the selection. Here, the plausible detection signals are used to generate the output signals/control signals. In principle, the check of the centrifuge device can be carried out manually or automatically. If the check is carried out automatically, a direct check of the operating parameters of the centrifuge device is preferably carried out by the software module with the output signals/control signals. If the check is carried out manually, an alarm/information for a user is preferably generated by the software module with the output signals/control signals, which informs the user how and which operating parameters of the centrifuge device must be adapted.

Within the framework of the invention, the plausibility check of signals can be understood, inter alia, as the verification as well as the selection of signals with regard to their plausibility. In this situation, the selection of signals with regard to their plausibility can be based, inter alia, on a tolerance range in which the signals can deviate from each other, from an average value, from a predeterminable value or from a desired value. Signals, which are selected as non-plausible signals are preferably sorted out and not processed further, i.e. not used to generate output signals. The plausibility check (often also plausibility control, plausibility test or plausibilization) is in particular a method in the framework of which a value or a result in general is checked whether it can be plausible at all, i.e. acceptable, reasonable and comprehensible or not. Within the framework of the application of the plausibility check in a method for operating a centrifuge device, a misinterpretation of the software module can be prevented by the plausibility check, so that the centrifuge device is not mis-controlled. In principle, a plausibility rule can be established for plausibility check, which must be fulfilled by the detection signals. Plausibility rules can be expressed as a formula and can describe permissible limit values, the ratio of related detection signals to each other or similar. It is also possible to check the detection signals during the plausibility check for their (plausible) value range and their temporal course and to select them on the basis of this. The plausibility check can also be carried out by a cross-comparison with alternative data sources (e.g. look-up tables) and other detection signals. In addition, the plausibility check can comprise Deep Learning, whereby splashes on the detector (e.g. on the camera lens), foam formation, wave formation and many other interfering factors can be detected, and the signals can be selected accordingly, or the signals can be reacted to accordingly. Furthermore, it is easier to use the entire camera image for the plausibility check with Deep Learning instead of only individual image sections or lines. Here, Deep Learning is to be understood as, inter alia, an optimization method for artificial neural networks with numerous intermediate layers between an input layer and an output layer, thereby creating an extensive internal structure. With such an arrangement, extensions of the learning algorithms for network structures with very few or no intermediate layers can be made possible, whereby the methods of Deep Learning enable a stable learning success of the system.

During the plausibility check, even the best detection signals can be selected and prioritized accordingly.

In a light detector and the underlying software, signal loss (e.g. filling level or intensity monitoring) can occur repeatedly. To avoid misinterpretation, the plausibility check is used according to the invention. If the signal starts to jump or override, it is no longer plausible.

As already described above, a comparison of the detection signal with a desired value can take place during the selection during the plausibility check of the detection signals by the software module. This desired value can be predetermined as a predeterminable value in the software module. In addition, the desired value can be regarded as a kind of limit value or ideal value.

In addition, the cross-comparison can be used during the selection for plausibility check of the detection signals by the software module. For the cross-comparison, at least a first detection signal is compared with a second detection signal in order to check the plausibility of the detection signals.

In special cases, the plausibility check, i.e. the check of the plausibility of the detection signals, can be carried out in such a way that, for example, certain detection signals can only occur in certain combinations and sequences. Otherwise, the detection signal is selected as “non-plausible”. Here, the detection signals can be tested in particular for their (plausible) value range and their temporal course.

Alternatively, or in addition to the plausibility options described above, the light detector can be connected to the software module at least by a first and a second inlet. For plausibility check of the detection signal by the light detector by the software module, a third detection signal is used by carrying out a cross-comparison between a first input of the first inlet and a second input of the second inlet of the third detection signal. This means that the first and the second input of the same third detection signal are compared, which is forwarded to the software module via two different paths (inlets). Using such a plausibility check, for example, it can be prevented that incorrectly transmitted detection signals are used to control the centrifuge device. The first input of the first inlet and the second input of the second inlet are therefore to be understood as the detection signals transmitted to the software module. The first and the second inlet then represent the transmission path. The first and/or the second inlet can be a connection with cable (electrical conductor or optical waveguide) or a wireless connection (transmission takes place by directional or non-directional electromagnetic waves, usually radio frequency range). A wireless connection is to be understood, inter alia, as Wlan, Bluetooth and NFC.

Analogous to the transmission described above, several detection signals can of course also be transmitted via several inlets. Thus, a fourth detection signal can be transmitted from the light detector to the software module via a fourth inlet and a fifth detection signal via a fifth inlet.

If there are several inlets, which pass on the same detection signal from the light detector to the software module, the correct signal transmission can also be checked for plausibility by comparing the transmitted detection signals with each other and only the valid, i.e. plausible, detection signals are processed into output signals.

If several detection signals are compared during the plausibility check via the cross-comparison, the differences of the different detection signals can be determined in order to determine a tolerance value with these differences with which the different detection signals can be checked for plausibility.

In practice, the filling material parameter detected by the reflected light can correspond to an intensity of a surface of the filling material in the centrifuge. In doing so, a liquid supernatant and/or a dryness and/or a degree of purity of the product can be detected by the intensity. If the intensity of the surface has been detected, a degree of moisture (with reference to liquid supernatant and/or dryness and/or degree of purity) of the filling material in the centrifuge drum can be deter mined. The detection signals of the intensity are checked for plausibility and the plausible detection signals of the intensity are used to generate at least one control signal for changing the operating parameters of the centrifuge device. Depending on the degree of moisture, different changes of the operating parameters (control and regulation of the operating parameters) can be necessary. If the solids cake is too moist, the rotational speed of the centrifuge drum can be increased, if the product (i.e. usually the largely cleaned filling material) is too impure in the centrifuge drum, a further washing step can be carried out. In addition, the filling flow (flow of the filling material through the centrifuge, continuous) can be adapted, e.g. reduced or increased. By checking the plausibility of the detection signals of the intensity of the surface of the filling material, “false/faulty” detection signals can be prevented, i.e. non-plausible detection signals, are used to generate output signals and that the operating parameters of the centrifuge device are thus changed unnecessarily or incorrectly. In this way, it can be prevented, inter alia, that material is lost by unnecessary washing steps and that the impure product is removed from the centrifuge device. In addition, an unbalancing of the centrifuge device due to liquid supernatant can be avoided.

The detection signals can in particular be detected by the camera image, from which the intensity is obtained as a detection signal, so that it is possible to distinguish between liquid supernatant and dryness of the product surface via the intensity differences in the camera image. If the color of the surface, i.e. the intensity of the product surface, changes when the product is washed, the degree of purity of the product in particular can be detected. In an embodiment of the invention, the purity of the product can also be determined by a predefined color tone. The detection signals described above are checked for plausibility, converted into output signals, and can be passed on to a higher-level controller.

To detect the intensity, different (e.g. rectangular) areas can be defined in the camera image, which are then processed and compared.

If the light detector is designed as a camera, the intensity of the filling material surface can in principle also be detected as gray scale intensity. The greater the difference in contrast in the gray scale transitions, the better the filling level can be detected. For example, an increasing signal of gray intensity may indicate that the filling material is drying, while a decreasing signal may indicate that a liquid supernatant is present/is increasing.

With a light detector according to embodiments of the invention, the filling level and thus the degree of filling in the centrifuge drum can also be detected without contact. The detection signals are also checked for their plausibility. A detection signal is, inter alia, plausible if it is not overridden (e.g. signal value 120%), does not jump and is within the tolerance range within a measuring period.

Depending on the design of the method according to the invention, the filling material parameter detected by the reflected light can also correspond to a color of a color edge between the filling material and the centrifuge drum. The detection signals of the color of the color edge between the filling material and the centrifuge drum are checked for plausibility and the plausible detection signals of the color of the color edge are used to generate at least one control signal for changing the operating parameters of the centrifuge device. Here, a filling level of the filling material in the centrifuge can be determined by the color of the color edge. After the plausibility check, the plausible detection signals of the color of the color edge can be used to generate at least one control signal for changing the operating parameters of the centrifuge device. In particular, the control signal can be used to control or regulate a filling material supply.

In principle, there must not only be one single filling material parameter, which is detected. Preferably, even more than one filling parameter is detected, in particular the color of the color edge between the filling material and the centrifuge drum as the first filling material parameter and the intensity of the surface of the filling material as the second filling material parameter. The detection signals of the first filling material parameter and the second filling material parameter are checked for plausibility in order to prevent that “false/faulty”, i.e. non-plausible detection signals, are used to generate output signals/control signals. The detection of a large number of different operating parameters allows a comprehensive control of many operating parameters of the centrifuge device.

The determination of the color edge is preferably made by the light detector detecting along an edge between the centrifuge drum and the surface of the filling material (e.g. along a definable line) which searches for transitions in intensity, in particular for transitions of a grey scale intensity and thus determines the color of the color edge between the filling material and the centrifuge drum. In this way, a level (i.e. also the filling level) of liquids and solids in the centrifuge device can be measured.

In principle, a large number of different filling material parameters can be detected in a method according to embodiments of the invention. However, the fact that a filling parameter is detected cannot be limited to the fact that this parameter is detected directly. The filling material parameters are often detected indirectly and/or via an auxiliary variable. Thus, both the intensity of the surface of the filling material and the color of the color edge between the filling material and the centrifuge drum are detected by electromagnetic radiation, preferably in the visible light range. For this purpose, the reflected radiation is detected by the light detector and then interpreted, i.e. in the case of the camera it is converted into an image from which the color of the color edge and the intensity of the surface are then determined. In addition, the measured auxiliary variables can also be converted into the desired filling material parameters via a look-up table or an equation. Further filling material parameters, which are detected by a light detector according to the invention are, inter alia, also the chemical composition and the density of the filling material. The chemical composition of a filling material can, for example, also be determined by a fluorescence measurement (i.e. preferably intensity).

In the method according to one embodiment the invention, a control signal can be used to control or regulate an amount of filling material, which is supplied to the centrifuge device. The exact amount of filling material to be supplied can be determined by such a control signal, or whether a supply of filling material is necessary at all. In addition, the filling speed (i.e. the speed of the supply of the filling material) can be determined and adapted via a corresponding control signal. In doing so, overfilling and underfilling of the centrifuge drum and thus unbalance and inefficiency can be avoided. Furthermore, a control signal can be used in the method according to the invention for on or off control or regulation of the washing step in order to avoid that an excess of washing liquid is applied to the filling material. In the method according to the invention, a control signal can additionally be used for controlling a rotational speed of the centrifuge drum. Here, the control signal can comprise acceleration, pause and/or deceleration. The control signal can of course also be used to extend and retract a scraper arm. In principle, the control signals can be stored/deposited in the software module and triggered when a certain control signal causes this. For this purpose, this control signal can in particular be transferred from the CPU to the higher-level controller. On the basis of the control signal (or several different control signals from different filling material parameters), it is possible to decide in particular whether and what action is necessary to check the operating parameters of the centrifuge device.

Furthermore, embodiments of the invention relate to a centrifuge device for use in a method according to the invention. In one embodiment, the centrifuge device comprises a centrifuge in which a centrifuge drum is rotatably arranged. Separation of a liquid and a solid phase of the filling material arranged in the centrifuge drum is achieved by rotation of the centrifuge drum. This separation can be checked by the method according to the invention. In addition, the centrifuge device according to one embodiment of the invention comprises a light detector and a light source. The light detector and the light source are arranged on the centrifuge device in such a way that a detection of a detectable filling material parameter can be carried out in an interior of the centrifuge drum. In addition, the centrifuge device according to the invention comprises a software module for plausibility check the a filling material parameter detectable by the light detector. The software module can be connected to the light detector by an inlet for receiving detection signals.

As a further component, embodiments of the invention relate to an integrable device for use in a method according to the invention. The integrable device comprises a light detector and a light source, wherein the light detector and the light source can be arranged in an interior of a centrifuge device for detecting a detectable filling material parameter. In addition, the integrable device comprises a software module for plausibility check of a filling material parameter detectable by the light detector, wherein the software module is connected to the light detector by an inlet for receiving detection signals.

Within the framework of the invention, the centrifuge of the centrifuge device can be, inter alia, a pusher centrifuge, a basket centrifuge, a screen screw centrifuge, a scraper centrifuge, an inverting centrifuge or a decanter centrifuge.

### BRIEF DESCRIPTION OF DRAWINGS

The invention will be explained in more detail hereinafter with reference to the drawings.

FIG. 1 is an embodiment for a procedure according to the invention;

FIG. 2 is a first embodiment of a centrifuge device according to the invention;

FIG. 3 is a second embodiment of a centrifuge device according to the invention;

FIG. 4 is a third embodiment of a centrifuge device according to the invention with a display window; and

FIG. 5 is a fourth embodiment of a centrifuge device according to the invention.

### DETAILED DESCRIPTION

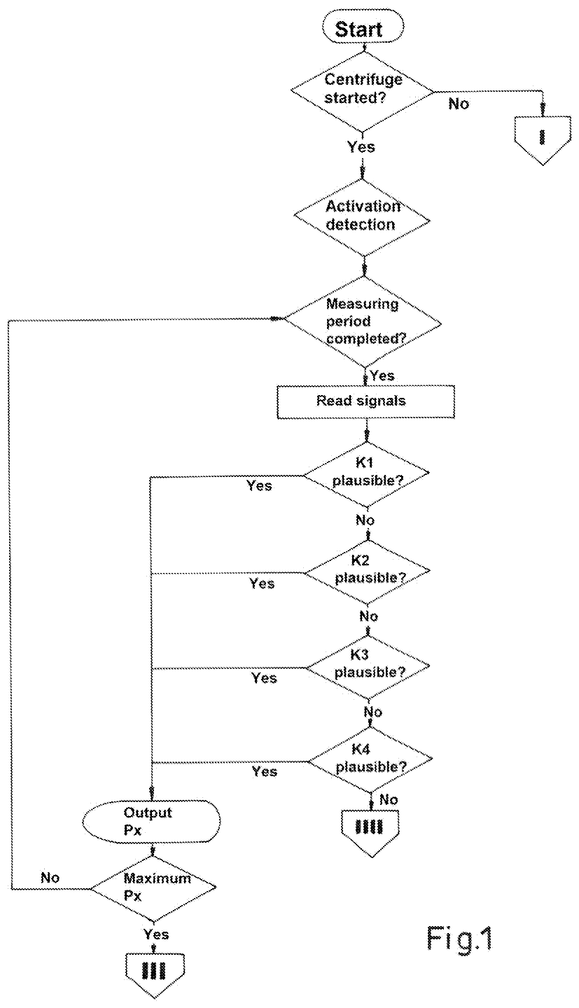

FIG. 1 shows an embodiment for a procedure according to an embodiment of the invention. Thus, a method for operating and checking a centrifuge device is shown and represented by a program sequence. In this embodiment, the method for operating the centrifuge device by detecting the filling material parameter of the filling material inside the centrifuge drum comprises the following steps.

“Start” starts the program that carries out the method according to the invention. In the step “Centrifuge started?”, it is checked whether the centrifuge device is switched on or in operation. If the centrifuge device is not in operation, step “I” follows, if it is in operation, the step “activation detection” follows.

In step “I”, either the program is terminated, or the centrifuge device is switched on/put into operation. In the step “activation detection”, the light detector and the light source are activated.

After the step “activation detection”, at least a part of the surface of the filling material is illuminated by the light source and the light reflected by the filling material is detected by the light detector.

If a measuring period has been completed (“measuring period completed”), the detected detection signals are transmitted to the software module via the inlet and the generated detection signals are read in in the software module in the step “read signals”.

The detection signals read in are checked for plausibility in the steps “K1-K4 plausible?” by comparing the detection signals, e.g. via a cross-comparison and/or a tolerance range. Here, in particular, a detection signal K can be selected as non-plausible if it has a large difference to the other detection signals. In a step “1111”, the non-plausible detection signals are either sorted out, corrected or stored in a database for correction.

In step “output Px”, the plausible detection signals are converted into an output signal/control signal. In the step “maximum Px”, it is decided on the basis of the output signal whether an action, i.e. a change in the operating parameters of the centrifuge device, is necessary.

If a change is necessary, at least one operating parameter of the centrifuge device is adapted in step “III” and, if necessary, a new measuring period is completed. If no change is necessary, only a new measuring period is completed.

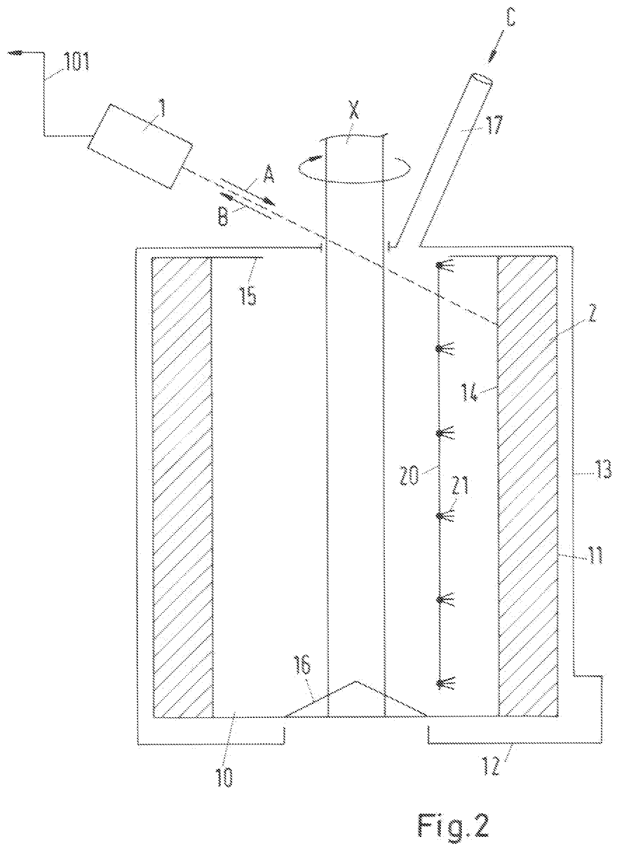

FIG. 2 shows a first embodiment of a centrifuge device according to the invention. In FIG. 2, a typical structure for use in connection with the method according to the invention is represented. The structure shown in FIG. 2 comprises a centrifuge drum 10 rotatably arranged around the axis of rotation X in a batch centrifuge. Of course, the method according to the invention can be carried out in any type of centrifuge, in particular also in continuously operating centrifuges. For this purpose, the integrable device according to the invention must simply be mounted on the corresponding centrifuge.

The centrifuge drum 10 is arranged around the axis of rotation X in such a way that the centrifuge drum 10 can be rotated at a controllable rotational speed. As the centrifuge drum 10 rotates, the filling material 2 is pressed against the vertical sidewall 11 of the centrifuge drum 10. Since liquids can escape (possibly also enter) through the pinholes in the vertical side wall 11 during rotation of the centrifuge drum 10, the filling material 2 can be separated into a solid and a liquid phase. The liquid escaping (or entering) from the centrifuge drum 10 is collected in the outer casing 13 and is guided to the outlet channel 12 where the liquid can be discharged from the centrifuge device. The solid phase can leave the centrifuge drum 10 via an outlet 16 in the bottom of the centrifuge drum 10.

In the operating state of the centrifuge device, inter alia, the color and intensity of the filling material as well as its change, which leaves the centrifuge, can be monitored by the light detector 1 with a light source. It is indicated by the double arrow that light is cast from the light source onto the filling material in a step A. This light is reflected by the filling material in a step B and detected by the light detector B. In this way, a detection signal is generated from the detected reflected light, which can be used to check the centrifuge device after the plausibility check. For the plausibility check, the detection signals are transmitted from the light detector via an inlet 101 to the software module. Here, the detection signals can be transmitted via the inlet 101 with a cable or wirelessly.

In the present example, the light source is integrated into light detector 1. In principle, the light source can also be arranged on the light detector 1 or can be arranged separately from the light detector 1. The only important thing is that the light can be directed from the filling material to the light detector.

During the rotation of the centrifuge drum, the filling material 2 forms an inner surface 14 on which the light reaches from the light source. On the one hand, exactly this surface can be used for the detection of the intensity, as well as for the detection of the color of the color edge. In the operating state, it is ensured by an edge 15 that the filling material is held inside the centrifuge drum.

The light of the light source must hit (or illuminate) at least a part of the surface 14.

The centrifuge device further comprises a supply 17 via which the filling material 2 can be supplied along the arrow C into the centrifuge drum 10.

The light source of the integrated device can be, inter alia, a broadband light source such as a halogen lamp, which typically emits light in the wavelength range of 400-700 nm. As mentioned before, the light source can also be a Xenon flash lamp and/or a light emitting diode. As described above, other types of light sources can also be used for applications in the “non-visible area”.

In principle, the light detector 1 can also be a light detector arrangement 1, which comprises a large number of light detectors 1 and/or light sources. In a plurality of light detectors 1, each light detector 1 can be adapted to detect a predetermined wavelength or a predetermined wavelength range.

The reflected light from the surface 14 of the filling material 2 can also be used to determine the distance to the filling material 2 and thus the thickness of the filling material. This is the distance between the surfaces 11 and 14. If the distance to the filling material 2 varies over time, this can also be determined. An example of this can be when the filling material swirls around in the centrifuge drum. A filling material 2 swirling inside the centrifuge drum 10 can lead to unbalance and cause the centrifuge device to lose its equilibrium. Since the weight of the filling material 2 and the rotating centrifuge drum 10 can amount to several tons depending on the application, such an unbalance should be avoided. By detecting the thickness of the filling material 2 and its change, such an imbalance can be detected at an early stage.

The thickness of the filling material is determined by the distance from the light detector 1 and the light source to the surface 14 of the filling material 10.

A washing arrangement 20 for washing the filling material 2 is also provided. The washing arrangement 20 has a large number of nozzles 21, so that a homogeneous washing of the filling material 2 over the surface 14 is possible. As mentioned above, the light detector monitors, inter glia, the color of the filling material 14, whereby the effect of washing the filling material is also monitored and can be controlled accordingly. The washing of the filling material 2 can be carried out in particular in a washing step after separation of the liquid phase of the filling material 2. If an excess of washing liquid is applied to the surface 14 of the filling material 2, i.e. too much washing liquid is supplied, an undesirable liquid layer forms on the surface 14.

Such a liquid layer should be avoided as such a liquid layer can generate waves on the surface of the filling material 2 during rotation of the centrifuge drum 10, causing unbalance during rotation. Such a liquid layer can be detected on the surface 104 of the filling material 2 by the light detector and then the supply of washing liquid can be regulated or stopped.

Thus, the washing process can be controlled automatically (or alternatively manually) by a light detector according to embodiments of the invention. In one embodiment, it is ensured by checking the plausibility of the detection signals that there is no malfunction of the centrifuge device. Faulty signals can lead to faults in the control of the centrifuge device. In a washing step in particular, malfunctions mean that washing liquid is further supplied despite of the liquid layer or that too little washing liquid is supplied. However, such malfunctions can be avoided by checking the plausibility of the detection signals.

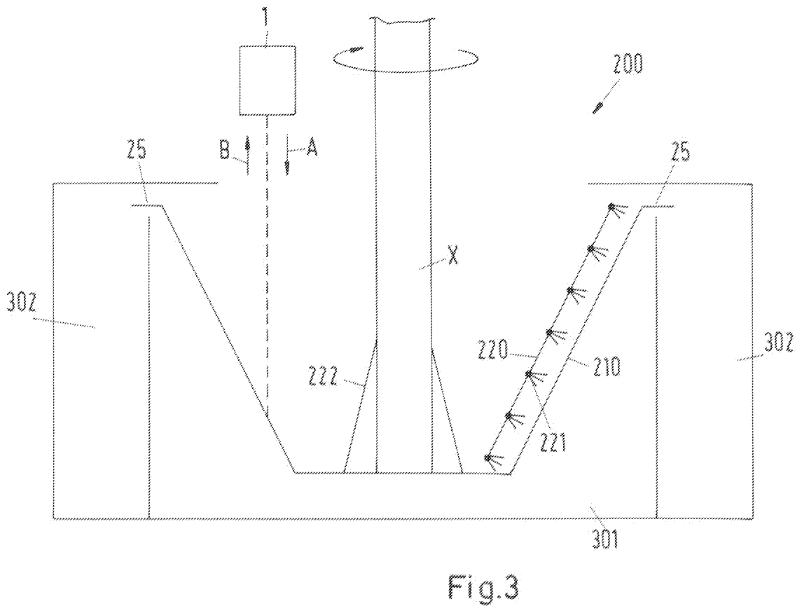

FIG. 3 shows a second embodiment of a centrifuge device according to the invention. In this case, this embodiment deals with a continuously operating centrifuge 200 with a centrifuge drum 210, which has the shape of a truncated cone 222. As represented in FIG. 3, the truncated cone 222 is directed upwards so that the largest diameter points upwards. During rotation of the centrifuge basket about the axis of rotation X, the separated liquid leaves the centrifuge drum 210 through its perforated sidewalls, while the solid phase leaves the centrifuge drum 210 at the upper edges 25 of the truncated cone. The liquid phase and the solid phase are therefore separated from each other and collected in separate reservoirs. Here, the liquid phase can be collected in a first reservoir 201, while the solid phase is collected in a second reservoir 302.

In the embodiment of FIG. 3, a washing arrangement 220 is also provided for washing the filling material. The washing arrangement 220 has a large number of nozzles 221, so that a homogeneous washing of the filling material can be carried out. In the centrifuge device of FIG. 3, a cone 222 is also provided in order to pre-accelerate the filling material before it hits the rotating centrifuge drum 210.

The light detector 1 with light source can be arranged either inside or outside the centrifuge drum 210 to monitor detection signals at a predeterminable point of the surface of the filling material inside the centrifuge drum 210. In FIG. 3, the light detector 1 is positioned outside the centrifuge drum 210. Similar to the arrangement in FIG. 2, both light is emitted (arrow A) and the reflected light is detected (arrow B). By monitoring the color of the color edge between the centrifuge drum 210 and the filling material and the intensity of the surface of the filling material at a predeterminable part of the surface of the filling material (or the centrifuge drum), the separation of the filling material can be monitored and checked by checking the operating parameters by the control signals generated from the detection signals, which are checked for plausibility.

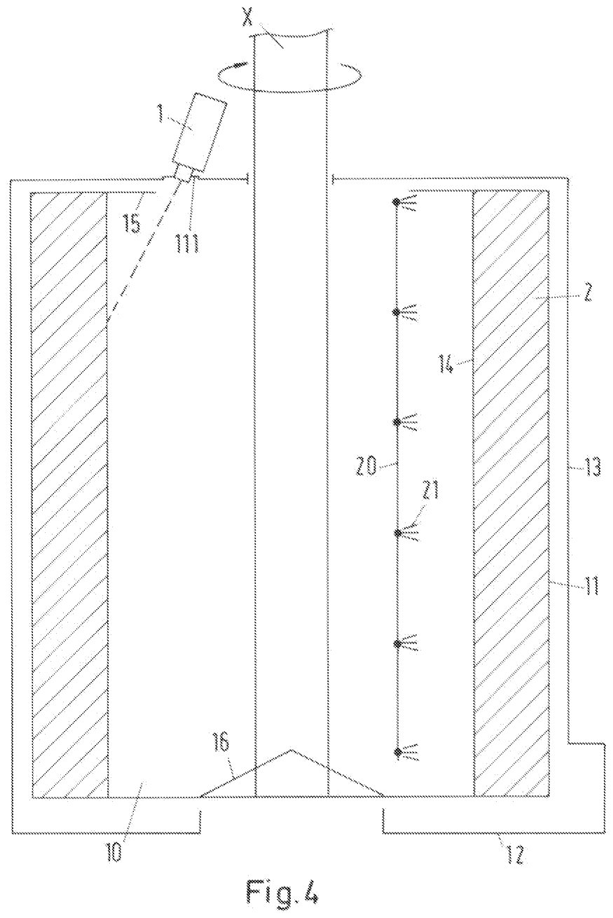

FIG. 4 shows a third embodiment of a centrifuge device according to the invention. The structure of the centrifuge device shown in FIG. 4 is largely analogous to the structure of the centrifuge device in FIG. 2. The centrifuge device thus comprises a centrifuge drum 10 with a vertical sidewall 11. The filling material 2 is separated into a liquid phase and a solid phase by rotation of the centrifuge drum 10 about the axis of rotation X. Here, the liquid phase is separated via the sidewalls 11 into the outer casing 13 and is discharged through the outlet channel 12.

The centrifuge device of FIG. 4 also comprises the washing arrangement 20 with a large number of nozzles 21, through which a washing liquid can be applied to the filling material.

The centrifuge device according to FIG. 4 differs from the centrifuge device in FIG. 2 in that the light detector 1 with the light source is arranged on a display window 11 outside the centrifuge device and the detection of the filling material parameters is achieved through this display window 111.

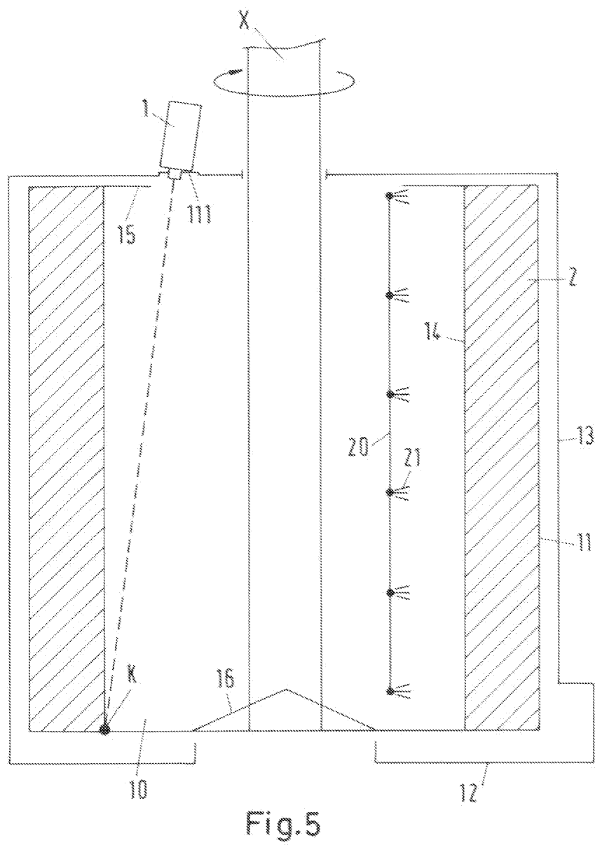

FIG. 5 shows a fourth embodiment of a centrifuge device according to the invention, in particular for edge detection for a light detector evaluation.

The structure of the centrifuge device shown in FIG. 5 is largely analogous to the structure of the centrifuge device in FIG. 2 and FIG. 4. The centrifuge device shown thus comprises a centrifuge drum 10 with a vertical sidewall 11. The filling material 2 is separated into a liquid phase and a solid phase by rotation of the centrifuge drum 10 about the axis of rotation X. Here, the liquid phase is separated via the sidewalls 11 into the outer casing 13 and is discharged through the outlet channel 12.

The centrifuge device of FIG. 4 also comprises the washing arrangement 20 with a large number of nozzles 21, through which a washing liquid can be applied to the filling material 2.

The centrifuge device according to FIG. 5 differs from the centrifuge device in FIG. 4 in that the light detector 1 detects an edge K between the centrifuge drum 10 and the surface of the filling material 2.

Here, the level (i.e. also the filling level) of liquids and solids can be measured. The light detector 1 detects along the edge K between the centrifuge drum 10 and the surface of the filling material 2 (e.g. along a definable line), which searches for transitions in intensity, in particular for transitions of a gray scale intensity and detects these. In principle, the greater the contrast difference in the gray scale transitions, the better the edge K of the filling level can be detected.

If a liquid supernatant occurs in the operating state of the centrifuge device, an intensity transition (intensity edge) forms between the filling material 2 and the centrifuge drum 10, and possibly also in the middle of the filling material 2. This intensity edge can be detected along the K edge.

However, the intensity can also preferably be measured (in the middle) on the cake, i.e. the product cake. As described above, the intensity determination of the solid cake/product is also suitable for determining the dryness and/or the degree of purity of the product.

The edge measurement (between filling material and centrifugal drum) is preferably used to determine the filling level. In an embodiment of the invention, how the edge measurement is applied, however, depends on whether the edge is a liquid or solid edge.

1. A method for operating a centrifuge device, the centrifuge device comprising
a centrifuge in which a centrifuge drum is rotatably arranged,
a light detector and a light source, the light detector and the light source being arranged on the centrifuge device such that detection of a filling material parameter is capable of being carried out in an interior of the centrifuge drum,
and a software module for a plausibility check of the filling material parameter detected by the light detector, the software module is capable of being connected to the light detector by an inlet for receiving a detection signal,
the method for operating the centrifuge device by detecting the filling material parameter of the filling material inside the centrifuge drum, comprising:
illuminating at least a part of a surface of the filling material with the light source, receiving a light reflected from the filling material by the light detector and generating a corresponding detection signal,
performing a plausibility check of the detection signal of the light detector with the software module,
processing a plausible detection signal by the software module, and
generating at least one output signal from the plausible detection signal by the software module.

2. The method according to claim 1, wherein the output signal is a control signal configured to change or maintain operating parameters of the centrifuge device.

3. The method according to claim 1, wherein the method is a method for monitoring and checking separation of a solid and a liquid phase or a filling level or a drying state of the filling material or a degree of purity of a product in the centrifugal drum.

4. The method according to claim 1, wherein the detection signal is one of a plurality of detections signals, and selecting each of the detection signal during the plausibility check, and dividing the detection signals into plausible and non-plausible detection signals during the selecting, the plausible detection signals being used to generate control signals.

5. The method according to claim 4, wherein the performing the plausibility check of the detection signals with the software module, includes comparing each of the detection signals with a desired value which is predetermined in the software module during the selecting.

6. The method according to claim 4, wherein the performing the plausibility check of the detection signals with the software module, includes cross-comparing during the selecting at least between a first detection signal and a second detection signal of the plurality of detection signals.

7. The method according to claim 6, wherein the inlet connecting the light detector to the software module is one of a first inlet and a second inlet and the performing the plausibility check of the detection signals from the light detector with the software module includes using a third detection signal by carrying out a cross-comparison between a first input of the first inlet and a second input of the second inlet of the third detection signal.

8. The method according to claim 1, wherein the light detector is a camera with a light source.

9. The method according to claim 1, wherein the filling material parameter detected by the reflected light corresponds to an intensity of a surface of the filling material in the centrifuge, a liquid supernatant or a dryness or a degree of purity of the product is capable of being detected by the intensity and the plausible detection signal of the intensity is used to generate the at least one control signal to change operating parameters of the centrifuge device.

10. The method according to claim 1, wherein the filling material parameter detected by the reflected light corresponds to a color of a color edge between the filling material and the centrifugal drum, a filling level of the filling material in the centrifuge is capable of being determined by the color of the color edge and the plausible detection signal of the color of the color edge is used after the plausibility check to generate the at least one control signal to change operating parameters of the centrifuge device.

11. The method according to claim 10, wherein the at least one control signal is capable of controlling or regulating an amount of the filling material supplied to the centrifuge device to prevent overfilling of the centrifuge drum.

12. The method according to claim 17, wherein the at least one control signal is capable of on or off control or regulation of the washing step to avoid an excess of washing liquid being applied to the filling material.

13. The method according to claim 1, wherein at least one control signal is configured to control a rotational speed of the centrifuge drum including acceleration, pause or deceleration.

14. The method according to claim 1, wherein the performing the plausibility check comprises deep learning.

15. A centrifuge device for use in a method according to claim 1, the centrifuge device comprising:
the centrifuge in which the centrifuge drum is rotatably arranged;
the light detector and the light source, the light detector and the light source being arranged on the centrifuge device such that the detection of the filling material parameter is capable of being carried out in the interior of the centrifuge drum; and
the software module configured to perform the plausibility check of a filling material parameter detectable by the light detector, the software module being connected to the light detector by the inlet for receiving detection signals.

16. An integrable device for the centrifuge device according to claim 15, the integrable device comprising:
the light detector and the light source, the light detector and the light source configured to detect the filling material parameter in the interior of the centrifuge device; and
the software module configured to perform the plausibility check of the filling material parameter detectable by the light detector, the software module being connected to the light detector by the inlet for receiving detection signals.

17. The method according to claim 1, wherein the filling material parameter detected by the reflected light corresponds to an intensity of a surface of the filling material in the centrifuge, a liquid supernatant or a dryness or a degree of purity of the product is capable of being detected by the intensity and the plausible detection signal of the intensity is used to generate the at least one control signal to control or regulate a washing step.

18. The method according to claim 1, wherein the filling material parameter detected by the reflected light corresponds to a color of a color edge between the filling material and the centrifugal drum, a filling level of the filling material in the centrifuge is capable of being determined by the color of the color edge and the plausible detection signal of the color of the color edge is used after the plausibility check to generate the at least one control signal to control or regulate a supply of filling material.
